(19) United States
(12) Patent Application Publication
(10) Pub. No.: US 2021/0381876 A1
(43) Pub. Date: Dec. 9, 2021

(54) DEVICE FOR STORING AT LEAST ONE BULK MATERIAL

(71) Applicant: NANO LIKE, LABEGE (FR)

(72) Inventors: Lucas DIGIANANTONIO, TOULOUSE (FR); David POIROT, TOULOUSE (FR)

(21) Appl. No.: 17/288,390

(22) PCT Filed: Oct. 23, 2019
(86) PCT No.: PCT/EP2019/078919

§ 371 Date: Apr. 23, 2021

(30) Foreign Application Priority Data
Oct. 24, 2018 (FR) 18 59833

(51) Int. Cl. G01G 3/14; B65D 77/04; B65D 77/06; G01G 23/18; G01F 13/00

(52) U.S. Cl. CPC G01G 3/14; B65D 77/0466; G01F 13/001; G01G 23/18; B65D 77/061

(57) ABSTRACT

The invention relates to a device for storing at least one bulk material (35), said device comprising:
a container (30) in which said bulk material, selected from the group composed of liquids and powdered materials, can be introduced, said container having a lower face (31) suitable to be able to be subjected to the weight of said bulk material introduced into said container,
a force measuring device comprising at least one force sensor (1) arranged beneath the base (31) of said container (30) and in contact with said base (31), each force sensor and the base of the container being arranged such that said force measuring device is only partially subjected to the weight of said bulk material introduced into said container.

The invention relates to a device for storing at least one bulk material comprising a force sensor. More particularly, the invention relates to a device for storing at least one bulk material allowing the determination of the filling rate of said container.

Intermediate bulk containers (IBC) are used in numerous fields, such as the chemical, pharmaceutical, food or cosmetic industries, or in the medical field. The most common intermediate bulk containers have a capacity of about 1.000 L. They can contain different types of liquid products, such as water, organic solvents, paints, hazardous chemical waste products, food raw materials or drinks, or powdered products such as raw materials in the form of beads, food powders, cereals (rice grains, wheat grains . . . ) or agricultural seeds.

The filling level or filling rate of such intermediate bulk containers is generally controlled empirically by operators and does not allow inventory management and the quantities of goods available to be optimally anticipated, nor any inventory shortage to be avoided.

It has been proposed ultrasonic sensors to be arranged within a container in order to determine the filling level of the container. However, the reliability of such sensors is affected especially by the exposure to the product introduced within the container.

There is known from CN207312306U a device comprising a container which can contain a liquid, a rectangular frame and a support comprising four force sensors arranged beneath the container so as to determine the total weight of said container and variations therein. The container rests solely on the four force sensors and the base of the container is spaced apart from the frame. The device according to CN207312306U further comprises a memory comprising the type of liquid within the container.

There is further known from WO 2005/037668 a container for tobacco comprising a weighing device allowing the weight of the tobacco in the container to be determined. The weighing device comprises load cells or pressure sensors.

There is further known from CN 103625736 a storage trolley comprising an upper plate and a lower plate, the upper plate having a slot provided with a weighing instrument allowing the total mass of the products arranged on the trolley to be determined.

However, such containers provided with such devices are expensive and do not allow use thereof in a generalised manner on an industrial scale for any type of product or industry, in particular in the field of transporting bulk materials. In particular, devices suitable for weighing of the order of 1.000 L of bulk material, namely often more than a ton, are all the more expensive.

The invention aims to overcome these disadvantages.

The invention aims in particular to propose an inexpensive device allowing data representing the filling rate of a container to be determined.

It further aims to propose such a device for which handling, storing, transporting, packing and installing operations are simple, do not require any particular precautions, can be effected by non-specialist operators and in no way risk affecting the performance of the force sensor.

It further aims to propose such a device which is resistant to the external environment, in particular humidity or adverse chemical or mechanical aggression, as well as temperature variations.

The invention thus relates to a device for storing at least one bulk material, said device comprising:
a container in which said bulk material, selected from the group composed of liquids and powdered materials, can be introduced, said container having a base suitable to be able to be subjected to the weight of said bulk material introduced into said container,
a force measuring device comprising at least one force sensor, each force sensor being arranged beneath the base of said container and in contact with said base, said force sensors and the base of the container being arranged such that said force measuring device is only partially subjected to the weight of said bulk material introduced into said container.

In other words, the weight of said bulk material present in the container rests only partially on the force sensor(s) (i.e. rests only partially on all of the force sensors) and in no way only on one set of force sensors. A device in accordance with the invention is thus differentiated from a device for measuring the total weight of a material contained in a container (or the total weight of a container with or without its contents).

Said force measuring device can comprise one or more force sensors (and comprises in particular all the force sensors arranged beneath the base of the container and in contact with the base of the container of the storage device). The invention thus relates in particular to a device for storing at least one bulk material, said device comprising:
a container in which said bulk material, selected from the group composed of liquids and powdered materials, can be introduced, said container having a base suitable to be able to be subjected to the weight of said bulk material introduced into said container,
a force sensor, in particular a single force sensor, arranged beneath the base of said container and in contact with said base, the force sensor and the base of the container being arranged such that said force sensor is only partially subjected to the weight of said bulk material introduced into said container.

In a storage device in accordance with the invention, the single force sensor or all of the force sensors of said force measuring device, in which each force sensor is arranged beneath the base of said container and in contact with said base, is/are not subjected to the total weight of the bulk material introduced into said container. The base of said container thus also rests on at least one element other than said force measuring device, namely it can for example rest on the ground or on any other support, such a support being separate from the container and thus from the base of the container.

The inventors have noted that the use of a force sensor on which said container only partially rests is sufficient to allow reliable determination of the filling rate of said container and/or of the variation in the filling level of said container. In particular, a device for storing at least one bulk material in accordance with the invention allows the filling rate of said container and/or its variation to be determined in a simplified and economical manner, without having to resort to measuring the total weight of the bulk material contained in said container, such measuring of the total mass (or total weight) necessarily implying that all of the weight of said bulk material introduced into a container is supported solely by the weighing device of such a device.

When a device in accordance with the invention is placed on a support, said support is subjected to the weight of said bulk material introduced into said container and to the weight of said container, the container likewise resting on said support. In some embodiments in accordance with the invention, said device comprises a support having an upper face for receiving the base of said container, the base of the container, the support and each force sensor being arranged such that at least one part of the base of the container is supported in direct contact with the upper receiving face, said upper receiving face being suitable to be able to be subjected at least partially to the weight of said bulk material introduced into said container.

When a storage device in accordance with the invention comprises a support, each force sensor can be arranged between the base of said container and said support or even said support can integrate at least partially each force sensor such that the support is subjected at least partially to the weight of said bulk material introduced into said container, each force sensor being subjected only partially to the weight of said bulk material introduced into said container.

A force sensor on which said container only partially rests, said container likewise resting on a support (separate from said force sensor), is sufficient to allow reliable determination of the filling rate of said container and/or of the variation in the filling rate of said container.

Throughout the text, the top and bottom and the terms “upper” and “lower” are defined relative to the Earth's gravitational field. In particular, since the container is arranged on said support, an element located at the top is on the container side and an element located at the bottom is on the support side.

Throughout the text, the expressions “a force sensor” or “said force sensor” apply to each force sensor of a force measuring device of a storage device in accordance with the invention.

Each force sensor can be arranged at any location on the upper receiving face, in particular substantially beneath the centre of the base of the container or between any peripheral edge of the lower face of the container (i.e. of the base) and its centre.

Said container can contain a flowable material, in the manner of a liquid, i.e. a material selected from the group composed of liquids and powdered materials (in particular powdered solids). Such materials are likewise called “bulk” materials.

A force sensor used in a storage device in accordance with the invention is autonomous, is not in contact with the contents of the container and is resistant to the transporting conditions of said containers, to the washing or cleaning thereof and to heat (e.g. to temperatures up to 90° C.).

In some embodiments in accordance with the invention, each force sensor comprises at least one sensitive element, an electrical characteristic thereof varying based on a force exerted by said container on said force sensor.

In some embodiments in accordance with the invention, each force sensor comprises at least one strain gauge.

A strain gauge has at least one electrical characteristic (generally resistance or capacitance) which varies as a function of a state of deformation of the surface of a solid material on which said strain gauge is arranged.

In some embodiments in accordance with the invention, each force sensor comprises a housing incorporating two strain gauges and one deformation element, the two strain gauges being fixed to said deformation element. In some embodiments in accordance with the invention, the housing of said force sensor is formed of rigid material.

In some embodiments in accordance with the invention, each strain gauge has at least one electrical characteristic which varies as a function of its deformation, said force sensor being arranged such that said electrical characteristic varies as a function of a state of deformation of said deformation element. The deformation element can be in various forms, e.g. the form of a plate, strip, beam, rod or even a spiral-type winding. The deformation element can be formed of at least one material selected from the group composed of metal materials, polymer materials, ceramic materials and composites thereof.

In some embodiments in accordance with the invention, said storage device in accordance with the invention comprises an electronic circuit:
connected electrically to each strain gauge,
suitable for measuring said electrical characteristic of each strain gauge, and for outputting a signal, named measuring signal, representing said electrical characteristic of each strain gauge.

Each strain gauge of a force sensor in accordance with the invention has electrical bonding pads allowing this strain gauge to be electrically connected to an electronic circuit suitable for measuring said electrical characteristic of the strain gauge.

Each force sensor in accordance with the invention can be of any shape and size, depending upon the applications, and in particular depending upon the number of, and type of, sensitive elements.

In some possible embodiments, a force sensor in accordance with the invention is in the form of a disc, having a diameter of the order of 1 cm to 5 cm, in particular of the order of 2 cm to 3 cm. The force sensor can likewise be in a generally parallelepiped shape having a width greater than 0.5 cm—in particular less than 10 cm, e.g. of the order of 1 cm to 3 cm—and a length greater than 2 cm—in particular less than 20 cm, e.g. of the order of 2 cm to 8 cm. Any other shapes (cylindrical portion, cap, prism, unremarkable shape . . . ) and sizes are possible.

In some embodiments in accordance with the invention, said force sensor has a smallest dimension, i.e. a thickness, between 1 mm and 15 mm.

In some embodiments in accordance with the invention, each force sensor has a substantially planar upper face, named contact face, said contact face being suitable to be able to be in contact with said lower face of the container. In some embodiments in accordance with the invention, said contact face of each force sensor (upper face of the housing of the force sensor) is suitable to be able to act on the deformation element of said force sensor (possibly via a piston arranged within said force sensor between the contact face of the force sensor and said deformation element).

In some embodiments in accordance with the invention, each force sensor has a fixing face suitable to be able to allow the fixing of said force sensor on the receiving face of said support.

The fixing face can be in any shape whatsoever and is adapted to the shape of the surface of the solid material on which the sensor is to be fixed. In particular, the fixing face can be planar. As a variant, the fixing face can be a skew surface, for example a cylindrical surface or a cap or a polyhedral or other type of surface. Therefore, the fixing face can be selected for example from the group composed of planar faces, concave cylindrical faces—in particular in the shape of a cylinder of revolution—, convex cylindrical faces—in particular in the shape of a cylinder of revolution—, concave spherical caps, convex spherical caps, concave parabolic caps, convex parabolic caps, concave polyhedral faces and convex polyhedral faces. The fixing face can likewise have any unremarkable skewed shape which is neither convex nor concave.

Said force sensor can be installed (adhered and/or screwed for example) on said support and/or on the base of the container or can even be simply positioned between the support and the container (before or after placing said container in or on the support).

In some embodiments in accordance with the invention, said device comprises an electrical accumulator. In some embodiments in accordance with the invention, each force sensor is connected to a secondary electronic housing comprising at least one electrical accumulator (a cell or battery pack for example) and a printed circuit board connected to said electrical accumulator. Said secondary electronic housing can likewise further comprise a wireless communication module. Such a secondary electronic housing has the advantage of allowing the size of the force sensor to be limited, since the secondary electronic housing can be arranged on a side of the container or at the level of its upper face or even fixed to the support or even integrated in the container or in the support, whilst being connected to said force sensor by a cable.

Alternatively, each force sensor can comprise a housing likewise comprising said electrical accumulator, said printed circuit board connected to said electrical accumulator and said wireless communication module, without having to provide such a secondary electronic housing. A single housing comprising the force sensor is thus disposed beneath the base of the container.

In some embodiments in accordance with the invention, said device comprises a wireless communication module. Such a communication module can allow the transmission and/or reception of any data relating to the container (its volume, its shape . . . ), to the type of bulk material contained in the container, to the temperature, to the filling level of said container . . . .

Such a wireless communication module can be selected for example from a radio-frequency communication module, an infrared communication module, an optical communication module, a magnetic communication module, an induction communication module. Advantageously, it can be a radio-frequency module allowing transmission of the measuring signal using any suitable radio-frequency protocol (Wi-Fi®, Bluetooth®, ZigBee®, SigFox®, LoRaWan®, mobile telephony protocol (GPRS, UMTS, LTE, WiMax . . . ) . . . ).

In some embodiments in accordance with the invention, each housing of the device can be formed from at least one polymer material for example selected from the group composed of polyimide, polyolefins (in particular polyethylene (PE)—in particular high density polyethylene (HDPE) or low density polyethylene (LDPE)—polyethylene terephthalate (PET), polypropylene (PP), polyethylene naphthalate (PEN), and cyclic olefin copolymer (COC)), polymethyl methacrylate (PMMA), polycarbonate (PC), polyether ether ketone (PEEK), polyvinyl chloride (PVC), acrylonitrile butadiene styrene (ABS), and halocarbon polymers (in particular fluorocarbons such as polytetrafluoroethylene (PTFE) and polyvinylidene fluoride (PVDF)).

The force measuring device can comprise one or more force sensors. In some embodiments in accordance with the invention, said force measuring device comprises a single force sensor. Although a single force sensor is sufficient for reliably determining the filling level of said container or the variation therein, there is nothing to prevent the force measuring device from comprising several force sensors, e.g. two, three, four or even five force sensors, or more (identical to or different from one another, preferably identical). A storage device in accordance with the invention comprising a force measuring device comprising at least two force sensors allows in particular the precision of the determination of the filling level to be increased.

Various embodiments may be envisaged in relation to the container of a device in accordance with the invention, in particular its size and shape. The container can be in the shape of a parallelepiped, cube, cylinder or more complex intermediate shapes such as a container having the shape of four cylinders juxtaposed two-by-two. In some embodiments in accordance with the invention, said container is generally substantially in the shape of a cube. The support associated with each container can likewise be in different shapes. A cubic container can for example be arranged inside a support which is itself a cube (or of one of two cube section(s)) having slightly larger dimensions. The support can be in the shape of a trough receiving only the lower part of the container and can have a shape conjugate to such a container which can itself have any of said shapes.

In some embodiments in accordance with the invention, said container has a maximum capacity between 5 L (0.005 m³) and 5000 l (5 m³), in particular between 50 l (0.05 m³) and 2000 l (2 m³), in particular between 100 L (0.1 m³) and 1.500 L (1.5 m³), and more particularly between 500 L (0.5 m³) and 1.200 L (1.2 m³).

In some embodiments in accordance with the invention, said container has an opening suitable for allowing the introduction of said bulk material inside said container. It can be for example an opening provided with a twist-off cap.

In some embodiments in accordance with the invention, said container is formed of at least one material selected from the group composed of metal materials, polymer materials, cellulose materials and composite materials. In some embodiments in accordance with the invention, said container is formed of at least one polymer material selected from the group composed of thermoplastic polymers and thermosetting polymers. In particular, the container of a device can be formed from at least one polymer material for example selected from the group composed of polyimide, polyolefins (in particular polyethylene (PE)—in particular high density polyethylene (HDPE) or low density polyethylene (LDPE)—polyethylene terephthalate (PET), polypropylene (PP), polyethylene naphthalate (PEN), and cyclic olefin copolymer (COC)), polymethyl methacrylate (PMMA), polycarbonate (PC), polyether ether ketone (PEEK), polyvinyl chloride (PVC), acrylonitrile butadiene styrene (ABS), and halocarbon polymers (in particular fluorocarbons such as polytetrafluoroethylene (PTFE) and polyvinylidene fluoride (PVDF)).

The container is formed from a material suitable for allowing the base of said container to be in contact with the upper face of the force sensor and also in contact with the support. This is the case for all of the containers of the intermediate bulk container type, taking into account the small thickness of a force sensor compared with the dimensions of the intermediate bulk containers. In some embodiments in accordance with the invention, said container has a base formed of at least one flexible material. In particular, the base of said container is formed of a more flexible material than that forming the force sensor (or in particular than the material forming the housing of the force sensor). In this manner, the base fits the shape of the housing of the force sensor to come into contact with the support. However, there is likewise nothing to prevent the use of a container with a base which is rigid (in particular at least as rigid as the housing of the force sensor). In the latter case, it should be ensured that the rigid base of the container is likewise in contact with the support, in particular by avoiding placing the force sensor beneath the centre of said base.

The invention further relates to a method for using a device in accordance with the invention and a method for determining the filling rate of a device for storing at least one bulk material comprising a container. The invention thus relates to a method for determining the filling rate of a device for storing at least one bulk material in which there is arranged at least one force sensor, in particular a single force sensor, beneath the base of a container and in contact with said base, said base of the container being suitable to be able to be subjected to the weight of a bulk material introduced into said container, by arranging each force sensor and the base of the container such that the force measuring device formed by said force sensors (or in particular the single force sensor) is only partially subjected to the weight of said bulk material introduced into said container. In some embodiments in accordance with the invention, each force sensor, in particular the single force sensor, is arranged between said base and said support, each force sensor being in contact with said base and in contact with said support. In particular, in some embodiments in accordance with the invention, each force sensor is arranged between said base and said support when said container is empty (does not comprise any bulk material). In some embodiments in accordance with the invention, after each force sensor has been arranged beneath the base of the container and in contact with said base, in particular when the container does not comprise any bulk material, said bulk material is introduced inside said container until a maximum filling level of said container is reached (this level not necessarily corresponding to the theoretically possible maximum filling level but to the maximum filling level desired or selected by the user).

The invention likewise relates to a device and method which are characterised in combination or individually by all or some of the features mentioned above or below. However they are formally presented, unless explicitly stated otherwise, the different features mentioned above or below should not be considered to be closely or inextricably linked with each other, the invention being able to relate to only one of these structural or functional features, or only some of these structural or functional features, or only part of one of these structural or functional features, or even any group, combination or juxtaposition of all or some of these structural or functional features.

Other aims, features and advantages of the invention will become apparent upon reading the following description given by way of non-limiting example of some possible embodiments thereof, and which makes reference to the attached figures in which:

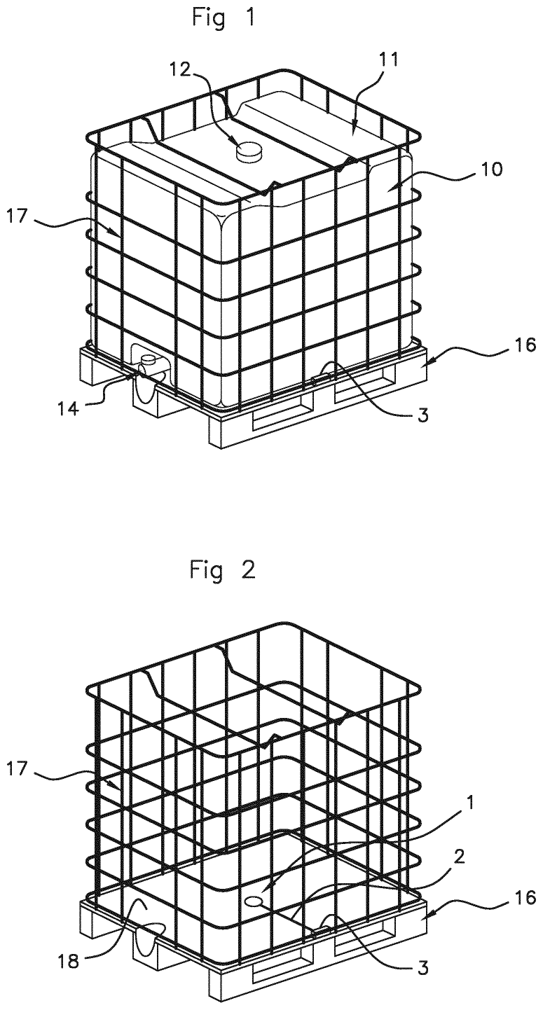

FIG. 1 is a schematic perspective view of a device in accordance with a first embodiment of the invention,

FIG. 2 is a schematic perspective view of the device of FIG. 1 in which the container has been removed,

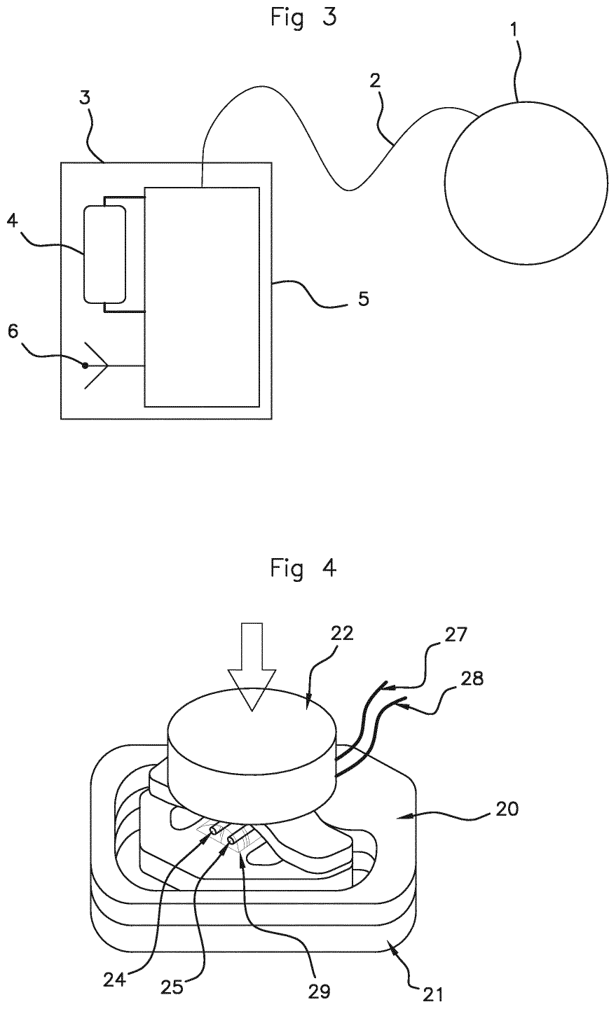

FIG. 3 is a diagram of the force sensor and of the secondary electronic housing of a device in accordance with the invention,

FIG. 4 is a schematic perspective view of the interior of a force sensor of a device in accordance with the invention,

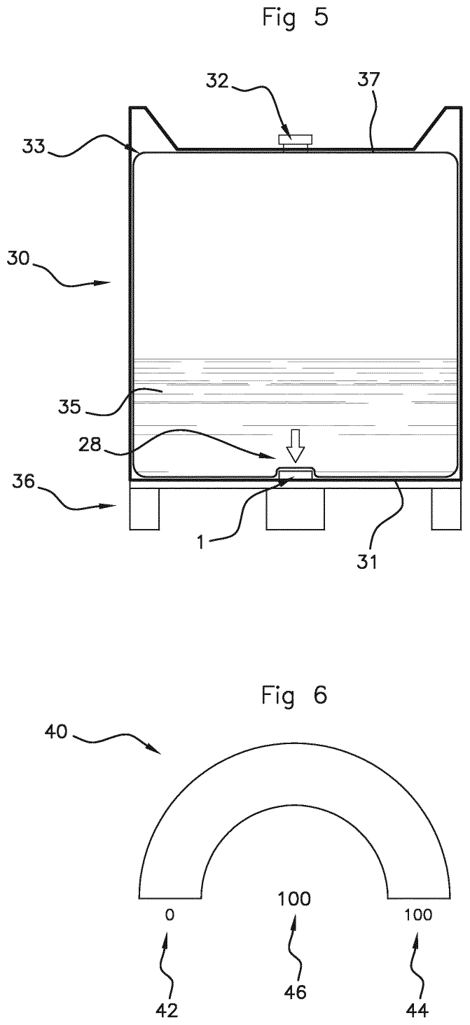

FIG. 5 is a schematic sectional view of a device in accordance with a second embodiment of the invention,

FIG. 6 is a diagram showing a result of the filling level of a container of a device in accordance with the invention.

The figures are not necessarily drawn to scale, in particular in terms of thickness, this being for illustrative purposes.

The device in accordance with the first embodiment of the invention shown in FIGS. 1 to 2 comprises:
a container 10 in which said bulk material, selected from the group composed of liquids and powdered materials, can be introduced, said container having a base suitable to be able to be subjected to the weight of a bulk material introduced into the container,
a force measuring device comprising a single force sensor 1 arranged beneath the base of the container 10 and in contact with said base so as to be only partially subjected to the weight of said bulk material introduced into said container,
a support 16 having an upper face 18 for receiving the container 10, said face being suitable to be able to be subjected at least in part to the weight of the bulk material introduced into the container.

In this first embodiment, the container 10 and the support 16 form an intermediate bulk container of the type comprising a support 16 having the form of a pallet allowing the device to be handled by a forklift truck. The support 16 is likewise accompanied by a mesh structure 17 (or mesh cage) suitable for receiving, protecting and mechanically reinforcing the container 10. The mesh structure 17 is generally made of metal and the pallet-like base of the support 16 can be made of a polymer material, of wood or even of a metal material or polymer-matrix composite material.

The container 10 is generally substantially in the shape of a cube. The container 10 has an opening 12 formed by a twist-off cap suitable for allowing the introduction of said bulk material inside the container, the opening 12 being arranged on the upper face 11, opposite the base of the container. The illustrated container 10 likewise comprises a liquid outlet in the form of a valve 14 provided at the bottom of one face on one side of the container.

In this first embodiment of a storage device in accordance with the invention, the force measuring device comprises a single force sensor 1, a single force sensor on which the container only partially rests being sufficient to allow reliable determination of the filling rate of the container and/or a variation in the filling rate of the container. However, there is nothing to prevent the force measuring device from comprising several force sensors, for example two, three, four or even five force sensors (identical or different, preferably identical). The use of a force measuring device comprising at least two force sensors allows the precision of the determination of the filling level to be increased by e.g. making two or three measurements of the filling level of said container in order to compare them.

The force sensor 1 is arranged in contact with the lower face of the container (forming the base of the container) and on the outside of the container. The force sensor 1 has an upper, substantially planar, contact face suitable to be able to be in contact with said base of the container 10. The force sensor 1 has a lower fixing face suitable to be able to allow fixing of said force sensor to the upper receiving face 18 of the support.

In the first illustrated embodiment, as shown in FIG. 2, the force sensor 1 is arranged substantially beneath the centre of the base of the container 10. However, there is nothing to prevent it being arranged at any other location between the base of the container and the support so long as the force sensor 1 is arranged substantially completely below the base of the container and on the face of the support for receiving said base.

The force sensor 1 is connected electrically by a cable 2 to a secondary housing 3 comprising an electrical accumulator (a battery pack 4) and a printed circuit board 5 connected to the battery pack 4. The printed circuit board 5 is composed of a module for acquiring the electrical signal from the force sensor 1 and a module for wireless communication which can return the data, e.g. over a low-power wireless network (also called LPWAN®). The secondary electronic housing 3 likewise comprises an antenna 6.

FIG. 3 is a schematic illustration of the force sensor 1 and of the secondary housing 3 which are electrically connected to one another.

The data collected are, for example, location, temperature or state of the vessel (full/empty, dirty/clean . . . ).

These data are, for example, sent with a sending frequency of one hour. The frequency of sending the data, the ON/OFF periods of the force sensor 1 or even the warning thresholds can be remotely parametrised.

FIG. 4 is a schematic illustration of the components of the force sensor 1. The force sensor 1 comprises an external housing (not shown in FIG. 4) incorporating two strain gauges 24, 25 coated with a resin 29, a deformation element 20, a base 21 on which the deformation element 20 rests, and a piston 22 which can transmit a force (indicated by the arrow shown in FIG. 4) to the tip of the deformation element 20. The force indicated by the arrow shown in FIG. 4 arises from the effect of the weight of the container and the bulk material contained in the container on the contact face of the housing of the force sensor, itself transmitted to the piston 22. The two strain gauges are fixed to the deformation element 20. Each strain gauge 24, 25 has at least one electrical characteristic which varies as a function of its deformation, the force sensor being arranged such that said electrical characteristic varies as a function of a state of deformation of the deformation element 20. The deformation element 20 can be in various forms different from that shown in FIG. 4, e.g. the form of a strip, beam or rod or even a spiral. The deformation element 20 can be formed of a metal material (in particular metal alloys), a ceramic material, a polymer material or a composite material.

The device further comprises an electronic circuit:
connected electrically to each strain gauge 24, 25 by cables 27, 28,
suitable for measuring said electrical characteristic of each strain gauge 24, 25, and for outputting a measuring signal, representing said electrical characteristic of each strain gauge.

The strain gauges 24, 25 are resistive strain gauges, i.e. the resistance thereof varies as a function of the deformation of the deformation part 20 which itself depends on the force exerted by the base of the container on the piston 22.

The second embodiment shown in the sectional view of FIG. 5 differs from the first embodiment in that it relates to a foldable intermediate bulk container comprising a container 30 formed of a sack 33 of flexible material arranged inside a rigid container 37 which can be folded into a configuration having a size less than its normal usage configuration. The container comprising the flexible sack 33 is arranged on a pallet. The device comprises a support 36 in the form of a pallet allowing the device to be handled by a forklift truck.

The container 30 has an opening 32 suitable for allowing the introduction of a bulk material 35 inside said container, the opening being arranged on the upper face, opposite the base 31 of the container.

The force sensor 1 is arranged in contact with the base of the flexible sack 33, in contact with it and on the outside thereof. In the second embodiment shown in FIG. 5, the force sensor 1 is arranged substantially in the centre beneath the base 31 of the container 30. However, there is nothing to prevent it being arranged at another location between the base of the container and the support 36, for example closer to one edge of the sack 33 of flexible material of the container. The results of measuring the filling rate of the container of an intermediate bulk container vary from one container to another (different material properties, geometries . . . ). A sensor placed beneath an intermediate bulk container returns a electrical resistance value which is converted into a deformation value (principle of a strain gauge). For an intermediate bulk container filled with 1.000 L of water, for example a deformation of 0.055% of the deformation element 20 is obtained and a deformation of 0.035% is obtained for 500 L of water. A law allows the volume (filling percentage or rate) to be linked with the deformation of the deformation element 20 of the force sensor 1, this law being able to be determined in particular from the first total filling of the container from its initial empty state, the measured force variation thus being considered as a variation of 0% to 100% of filling. The rate of introducing the bulk material into the container during this first filling does not need to be constant but can vary and the filling can be continuous or intermittent (in several filling steps). It is not necessary to know the maximum capacity of the container, nor the mass density of the bulk material introduced into the container, but these data can of course also allow the determined filling level to be refined. During emptying, the evolution of the force captured by the force sensor and the comparison of any value corresponding to the first maximum value captured by the force sensor (associated with a filling rate of 100%) allows a deduction to be made therefrom (using a mathematical law established based on particular parameters relating to the container and the type of bulk material in particular) as to the remaining volume in the container or a filling rate value and thus for example allows a warning to be given when this filling rate approaches zero or falls e.g. below 10%, 20% or even 30%. Despite a few approximations, the inventors have surprisingly noted that such a method allows a result to be obtained which has a precision between 2% and 20%, e.g. of the order of 10%, such a precision being largely sufficient and reliable for most applications and industries using such intermediate bulk containers.

FIG. 6 shows an example of presenting the result of measuring the filling rate of the container. The filling rate is shown in the form of an arc of a circle which can range from a minimum value 42 (of zero, i.e. 0%) to a maximum value 44 (of 100, i.e. 100%). The determined effective value 46 (100 in the example shown in FIG. 6) is shown beneath the arc of a circle.

The invention can cover numerous variants and applications other than those described above. In particular, it goes without saying that, unless stated otherwise, the different structural and functional features of each of the embodiments described above do not have to be considered as being combined and/or closely and/or inextricably linked with each other, but in contrast considered as simple juxtapositions. Furthermore, the structural and/or functional features of the different embodiments described above can form, in their entirety or in part, any different juxtaposition or any different combination. For example, containers having more complex shapes can be used. Furthermore, there is nothing to prevent the use of types of force sensors other than strain gauge sensors, for example hydraulic, pneumatic, piezoelectric force sensors or even beam deflection sensors.

1/ A device for storing at least one bulk material, said device comprising:
a container in which said bulk material, selected from the group consisting of liquids and powdered materials, can be introduced, said container having a base suitable to be able to be subjected to the weight of said bulk material introduced into said container,
a force measuring device comprising at least one force sensor arranged beneath the base of said container and in contact with said base, each force sensor and the base of the container being arranged such that said force measuring device is only partially subjected to the weight of said bulk material introduced into said container.

2/ The device according to claim 1, wherein said device comprises a support having an upper face for receiving the base of said container, the base of the container, the support and each force sensor being arranged such that at least one part of the base of the container is supported in direct contact with the upper receiving face, said upper receiving face being suitable to be able to be subjected at least partially to the weight of said bulk material introduced into said container.

3/ The device according to claim 1, wherein each force sensor comprises at least one strain gauge.

4/ The device according to claim 1, wherein each force sensor comprises a housing incorporating two strain gauges and one deformation element, the two strain gauges being fixed to said deformation element.

5/ The device according to claim 4, wherein each strain gauge has at least one electrical characteristic which varies as a function of its deformation, each force sensor being arranged such that said electrical characteristic varies as a function of a state of deformation of said deformation element.

6/ The device according to claim 5, wherein said device comprises an electronic circuit:
connected electrically to each strain gauge,
suitable for measuring said electrical characteristic of each strain gauge, and for outputting a signal, named measuring signal, representing said electrical characteristic of each strain gauge.

7/ The device according to claim 1, wherein each force sensor has a smallest dimension between 1 mm and 15 mm.

8/ The device according to claim 1, wherein each force sensor has a substantially planar upper face, named contact face, said contact face being suitable to be able to be in contact with said base of the container.

9/ The device according to claim 2, wherein each force sensor has a lower fixing face suitable to be able to allow fixing of said force sensor to the upper receiving face of the support.

10/ The device according to claim 1, wherein said force measuring device comprises a single force sensor.

11/ The device according to claim 1, wherein said container has a maximum capacity between 500 L and 1,200 L.

12/ The device according to claim 1, said container is generally in the shape of substantially a cube.

13/ The device according to claim 1, said container has an opening suitable for allowing the introduction of said bulk material inside said container.

14/ The device according to claim 1, said container has a base formed of at least one flexible material.

15/ The device according to claim 1, wherein said device comprises a wireless communication module.

16/ The device according to claim 1, wherein said device comprises an electric accumulator.
